(19) United States
(12) Patent Application Publication
(10) Pub. No.: US 2025/0163891 A1
(43) Pub. Date: May 22, 2025

(54) Wind Turbine Blade Lifter

(71) Applicant: Vacuworx Global, LLC, Tulsa, OK (US)

(72) Inventor: Mason Owen, Tulsa, OK (US)

(21) Appl. No.: 18/955,545

(22) Filed: Nov. 21, 2024

Related U.S. Application Data
(60) Provisional application No. 63/601,503, filed on Nov. 21, 2023.

(51) Int. Cl. F03D 13/10; B25J 15/06

(52) U.S. Cl. CPC F03D 13/104; B25J 15/0683; F05B 2230/61

(57) ABSTRACT

A vacuum material handler (10) is adapted to lift a wind turbine rotor blade for connection to a wind turbine tower. A first and second vacuum system (60) are connected to a main beam (30) of the handler and include a vacuum tank (61), valves (67), and vacuum lifting pads (21). Each lifting pad or pair of pads is in communication with one of the vacuum tanks (60A or 60B) and adjacent lifting pads or pairs of pads are in communication with the other vacuum tank (60B or 60A). Each lifting pad pivots in a upward and a downward direction fore and aft and side to side to accommodate and conform to the contour of the blade. The handler is lighter in weight than cradle and gripper systems, can be delivered by hotshot trailer, and does not require a cradle or the like to support the blade.

### CROSS-REFERENCE TO CO-PENDING APPLICATIONS

This application claims priority to, and benefit of, U.S. Application No. 63/601,503, filed Nov. 21, 2023.

### BACKGROUND

This disclosure is in the field of vacuum material handlers designed to lift wind turbine rotor blades from ground- or flat bed level upward to a hub connected to a nacelle of a wind turbine tower.

Wind turbine rotor blades may be about 35 m in length or longer, with some blades being about 85 m in length up to over 105 m in length. The blades, which typically comprise fiberglass and plastic resin, are also quite heavy. For example, a 50 m long blade may weigh about 6.4 metric tons. And because the blades have an aerodynamic design, typically in the form of an airfoil shape, the contour of the blades presents a lifting challenge when in the field to lift the blades into proper position for connection to a tower.

Prior art systems make use of a blade cradle, clamp, or gripper for lifting the blades for connection to the hub (which, in turn, is connected to the nacelle). See e.g., CTX Blade Gripper (Lifting Solutions Group, Axel Johnson International) and WO 2017/136428 to General Electric Company (disclosing cradle with vacuum system). Other systems make use of lifting equipment on the hub to raise each blade vertically for connection to the hub. See e.g., U.S. Pat. No. 10,119,522 to Nabrawind Tecnologies SL. Still other systems connect the blades to the hub at ground level and make use of a crane connected to the hub to lift the hub-and-blade assembly into position onto the nacelle.

A need exists for a wind turbine rotor blade lifter that is lighter in weight than prior art cradle and gripper systems, can be delivered in an assembled state on site via a hotshot trailer, and makes use of vacuum lifting throughout the lifting process without the need for a cradle, sling, or the like to support the blade.

### SUMMARY

Embodiments of a vacuum material handler of this disclosure include a vacuum lifting pad arrangement that is adapted to accommodate the contours of a wind turbine rotor blade regardless of where the blade is positioned relative to the pads. The vacuum lifting pads are in pivotal arrangement so that each may pivot upward and downward in a longitudinal (fore-and-aft) direction and a lateral (side-to-side) direction as needed to seal against the blade and apply vacuum. Half of the lifting pads is in communication with a first vacuum system and another half of the lifting pads is in communication with a second vacuum system. The pads are arranged so that adjacent pads or adjacent pairs of pads, either on a same side of the handler or on opposite sides, communicate with different vacuum systems. Should a vacuum pump or valve fail in one of the systems, or a hose connection become loose, the vacuum material handler still maintains the required lift force on the blade. For example, if one pair of lifting pads loses vacuum, the pair next to it on the same side of the handler, as well as the pair immediately opposite it, maintains vacuum because it is connected to the other vacuum system.

In embodiments, the vacuum material handler includes a longitudinally extending main beam and a first vacuum system and a second vacuum system connected to the longitudinally extending main beam. Each vacuum system includes a vacuum tank, a plurality of valves in fluid communication with the vacuum tank, and a plurality of vacuum lifting pads. The vacuum tank can be partially housed or contained by the beam with the valves connected to the tank. One vacuum tank may be located on one side of the beam and the other vacuum tank located on the other side of the beam.

Each vacuum lifting pad or pair of pads is in fluid communication with a corresponding one of the valves. arranged to pivot in a upward and a downward direction fore and aft and side to side. The number of valves may correspond to the number of lifting pads, with one valve dedicated to each lifting pad or pair of pads or lifter section containing the pads. In some embodiments, the number of lifting pads is N and the number of valves is N/2. By way of a non-limiting example, the number of lifting pads is 32 and the number of valves is 16, with 8 of the valves, and therefore 16 of the lifting pads, connected to the first vacuum system and another 8 of the valves connected to the second vacuum system.

Adjacent lifting pads or pairs or pads are in fluid communication with a different vacuum system than one another. The adjacent lifting pads can be located on opposite sides of the longitudinally extending main beam or on a same side of the longitudinally extending main beam (or some combination thereof). In some embodiments, the lifting pads in communication with the first vacuum system are arranged diagonal to one another along the handler to create a zig-zag pattern, as do the lifting pads in communication with the second vacuum system.

The vacuum material handler can further include at least one spreader beam connected to a bottom side of, and running in a same direction as, the longitudinally extending main beam. The at least one spreader bar can be pivotally connected to the longitudinally extending main beam. Lifting pads of the plurality of lifting pads are then connected to a bottom side of the at least one spreader bar. In some embodiments, there are three or more spreader beams spaced apart for one another. The beams may be of the same or different lengths. The spreader beam may be extendable in length.

The vacuum material handler may include another beam which can be pivotally connected to a bottom side of the spreader beam and running in the same direction as the spreader beam (and the main beam). Lifting pads of the plurality of lifting pads can be connected to the another beam. The vacuum material handler may further include two other beams that can each be pivotally connected to a corresponding end of the another beam but running in a lateral direction to that beam. The lifting pads of the plurality of lifting pads are connected to the two other beams and can be in pivotal relation to those beams. In some embodiments, one or more of the beams may I-beams or may be square or round tubes or bars.

A method of this disclosure for handling a wind turbine rotor blade for connection to a hub connected to a nacelle of a wind turbine tower, includes positioning the vacuum material handler directly above the wind turbine rotor blade; lowering the vacuum material handler to place the lifting pads in contact with portions of the wind turbine rotor blade; applying a vacuum to the lifting pads; and after the applying, lifting the wind turbine rotor blade for connection to the hub of the wind turbine tower. Contact with the blade causes the pads to rotate into a sealing orientation relative to the opposing contour or surface of the blade that permits the pad to hold vacuum. Vacuum can continued to be applied to the lifting pads during the connection to the hub. No cradle or other supporting structure is required during the lifting and connecting to support the weight of the blade. After the connection, the vacuum is released and the vacuum material handler is lowered to ground- or flat-bed level for further use or for transport.

### BRIEF DESCRIPTION OF THE DRAWINGS

FIG. 1 is an isometric view of an embodiment of a wind turbine rotor blade vacuum material handler of this disclosure. The handler is intended for use in the field to raise the blade upward for connection to a hub of a wind turbine tower. A plurality of articulated or pivoting vacuum lifting pad sections pads are connected to a beam of the vacuum lifter thereby permitting the vacuum lifting pads of each section to adapt to, accommodate, and seal against the contours of a wind turbine rotor blade.

FIG. 2 is a rear isometric view of the vacuum material handler of FIG. 1. A plurality of valves are arranged along the handler, with each valve in communication with a corresponding pair of vacuum lifting pads and a corresponding one of a first or second vacuum tank. The vacuum tank is in communication with a vacuum pump housed by a frame of the handler. The handler further includes the power source to drive the pump.

FIG. 3 is a front elevation view of the vacuum material handler of FIG. 1.

FIG. 4 is a top elevation view of the vacuum material handler of FIG. 1.

FIG. 5 is a side elevation view of the vacuum material handler of FIG. 1.

FIG. 6 is another rear isometric view of the vacuum material handler of FIG. 1, annotated to show in dashed lines the vacuum pads connected to a corresponding one of the vacuum tanks. The vacuum pads not within the dashed lines are connected to another one of the vacuum tanks. The vacuum pads connected to each spreader beam can comprise a lifting section, with half the pads of the section connected to one vacuum tank and the other half connected to the other vacuum tank. Each pair of vacuum pads could also comprise a vacuum pad section, with adjacent sections in communication with different vacuum tanks than one another. The pads opposite one another, that is, lying on opposite sides of the main beam, communicate with different vacuum tanks than one another.

FIG. 7 is another isometric view of the vacuum material handler of FIG. 1 when positioned onto a wind turbine rotor blade for lifting the blade up to a hub. When in use, the handler is connected to a crane (not shown). The air foil shape or contours of the blade are not shown here but the articulated or pivoting arrangement of the handler permits the lifting pads to accommodate whatever contour of the blade lies below it and apply vacuum to it.

FIG. 8 is an isometric view of another embodiment of a vacuum material handler of this disclosure. Unlike the handler of FIGS. 1-7, there are four spreader beams connected to the main beam and the vacuum lifting pads are longitudinally extending or rectangular in shape. A set of middle valves communicates with lifting pads connected to two middle spreader beams, the valves split between the two vacuum tanks. As in other embodiments of this disclosure, an alternating pattern is created, with one set of pads within a section being connected to one vacuum system and another set of pads within a sections being connected to the other vacuum system.

FIG. 9 is a rear isometric view of the vacuum material handler of FIG. 8.

FIG. 10 is a front elevation view of the vacuum material handler of FIG. 8.

FIG. 11 is a top plan view of the vacuum material handler of FIG. 8.

FIG. 12 is a side elevation view of the vacuum material handler of FIG. 8.

FIG. 13 another isometric view of the vacuum material handler of FIG. 1 when positioned onto a wind turbine rotor blade. Similar to FIG. 7, the air foil shape or contours of the blade are not shown here.

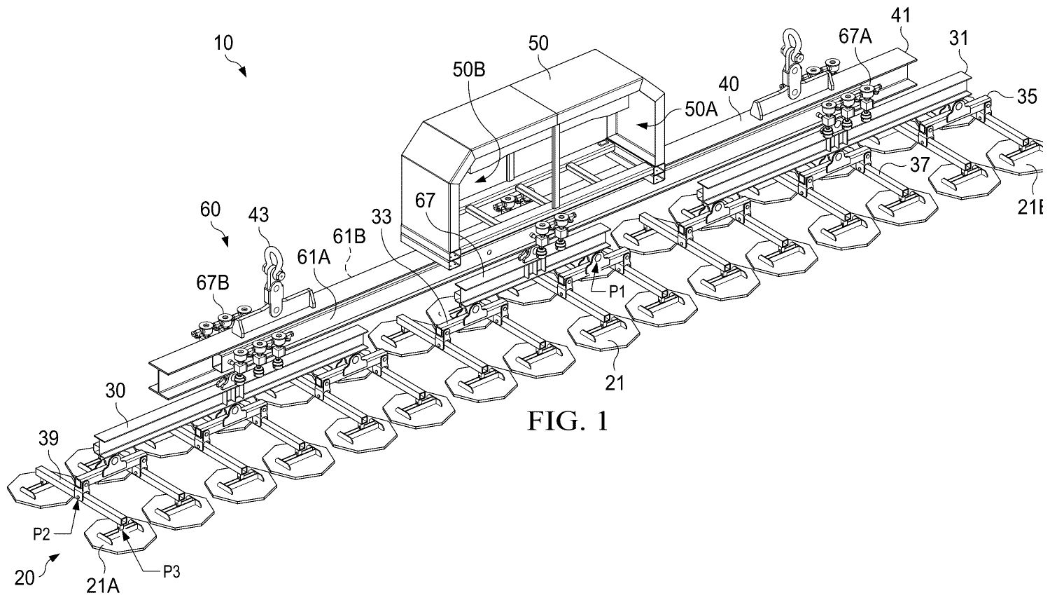

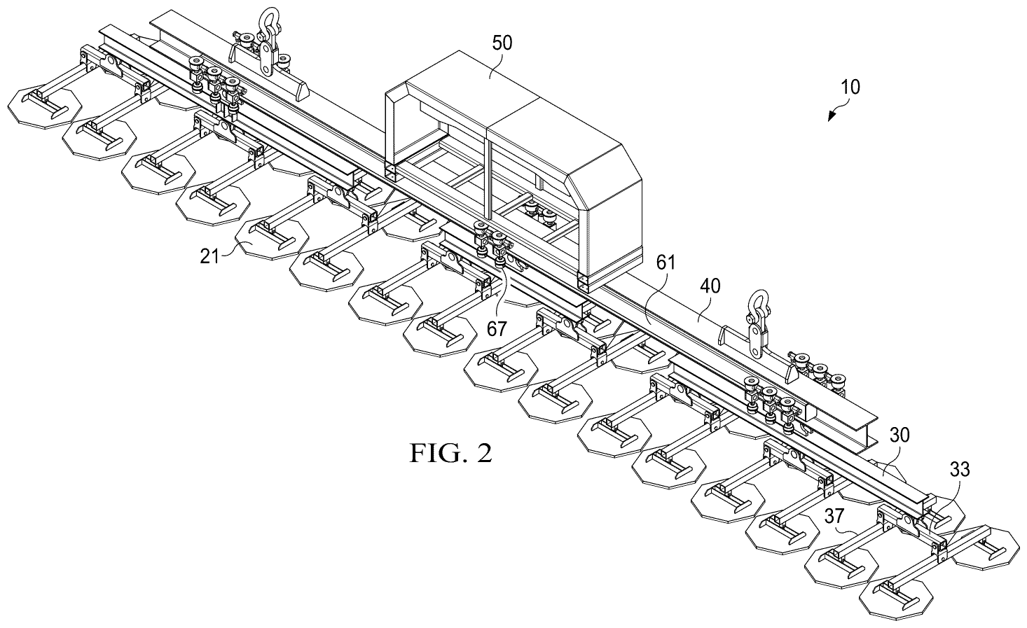

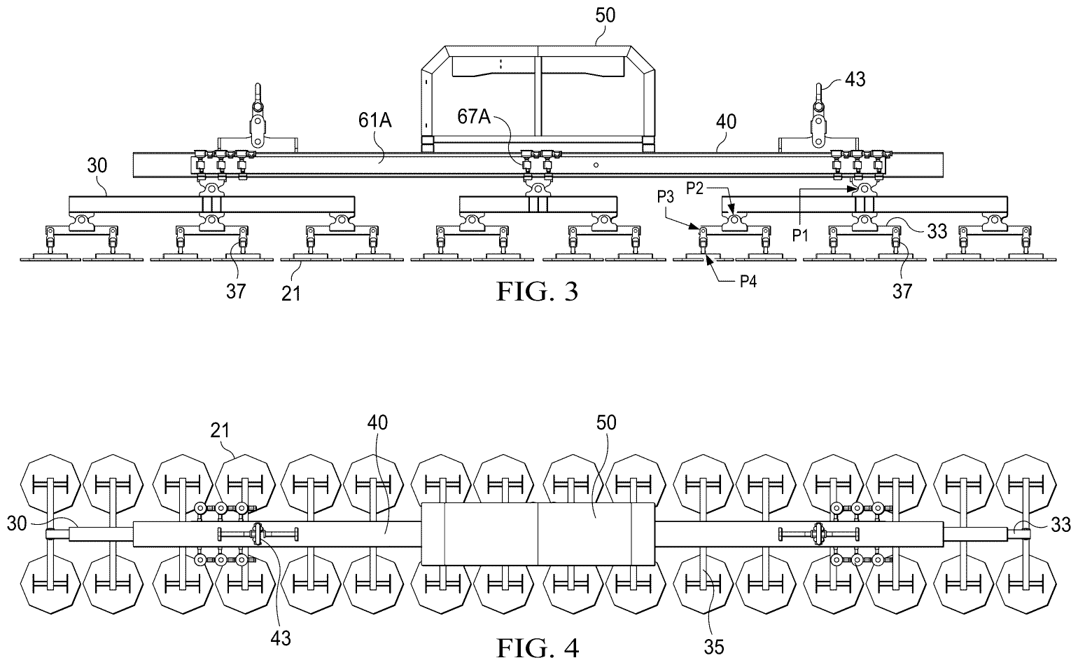

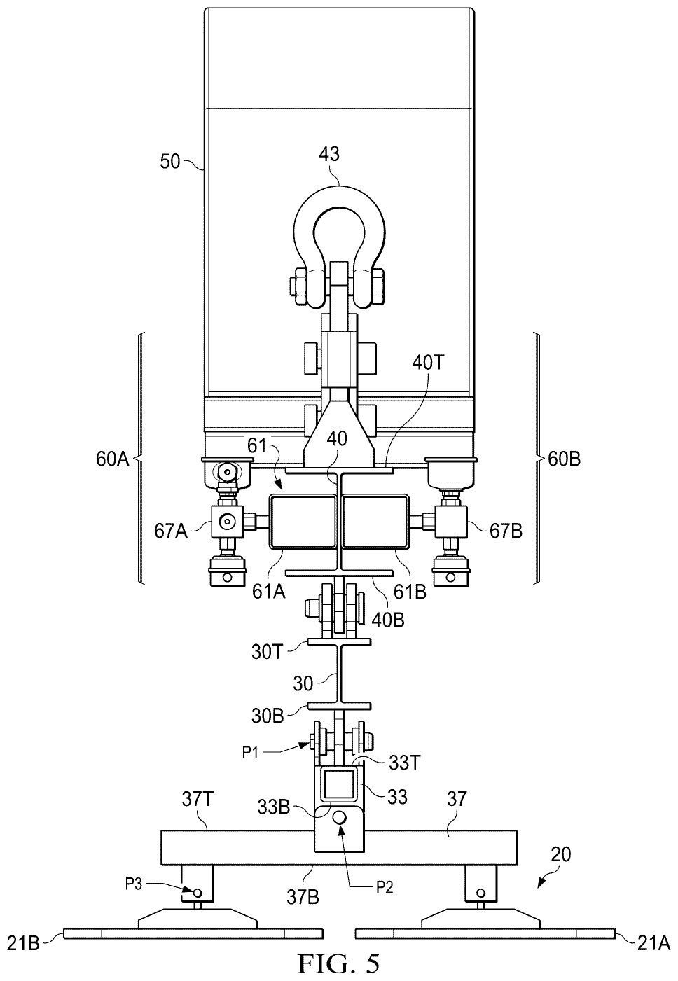

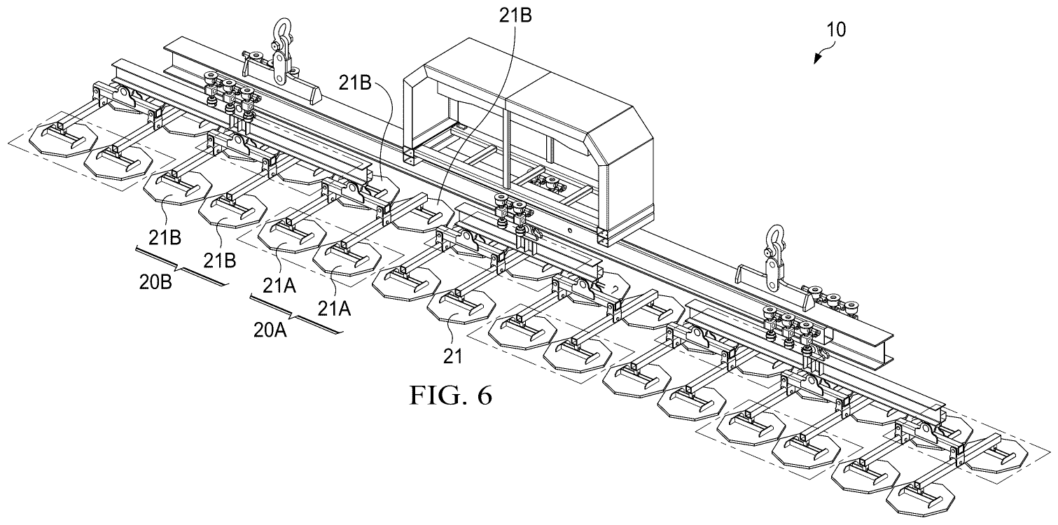

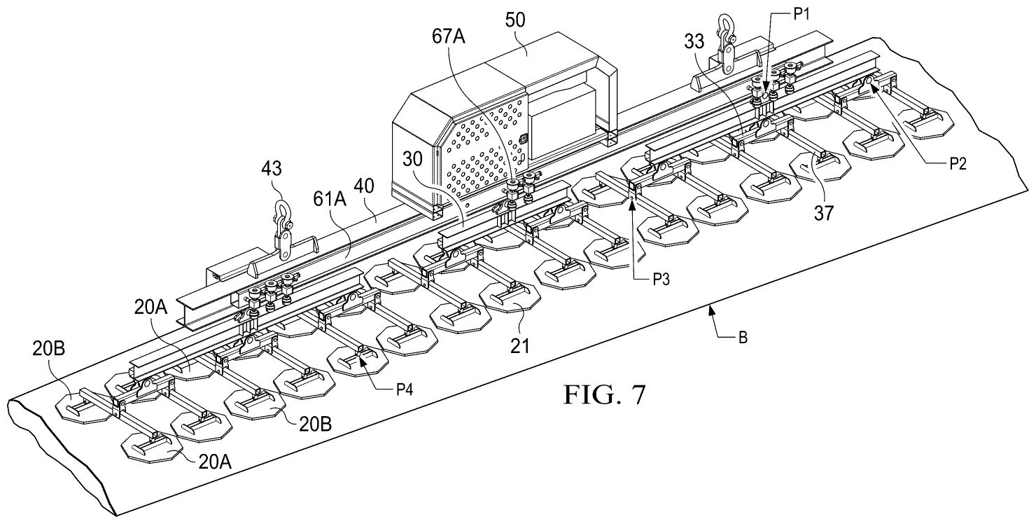

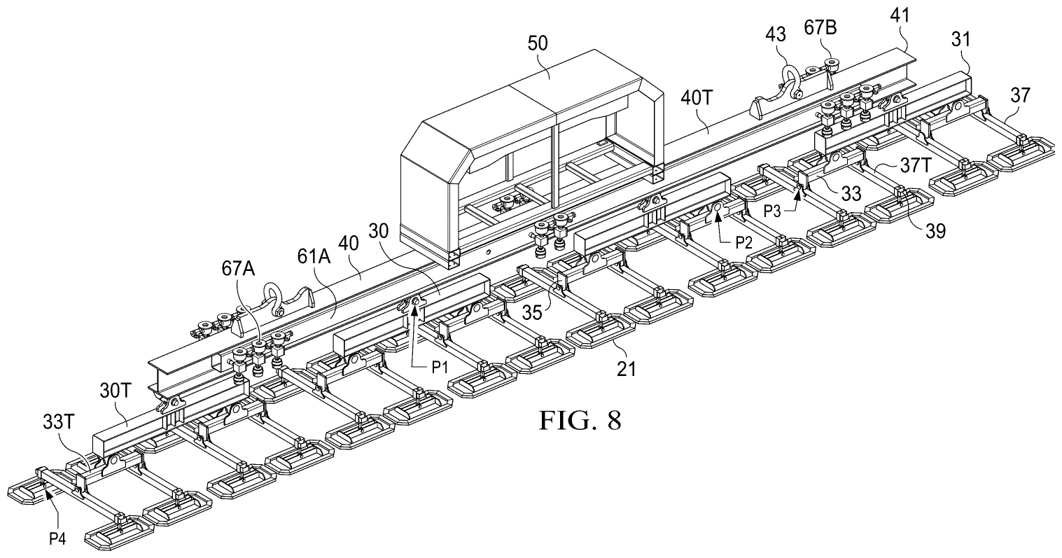

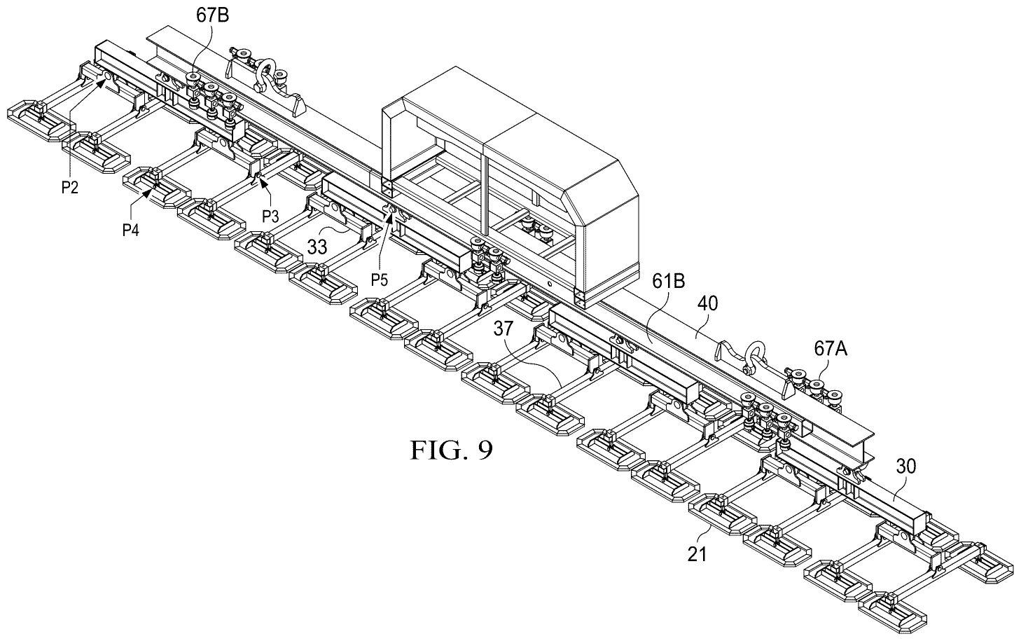

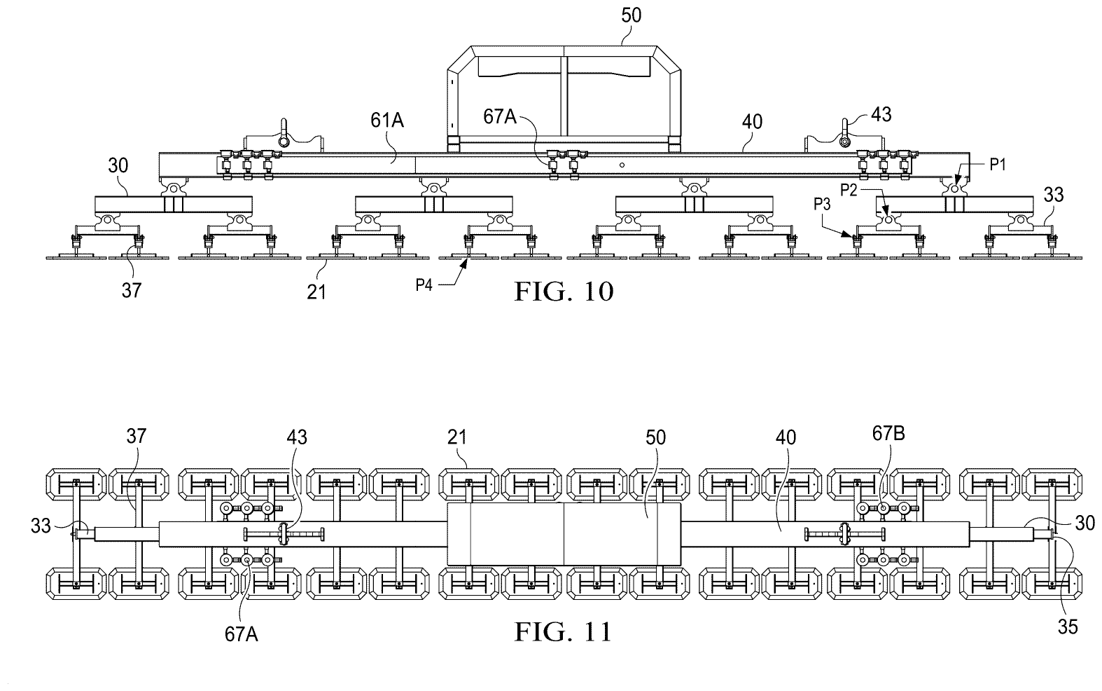

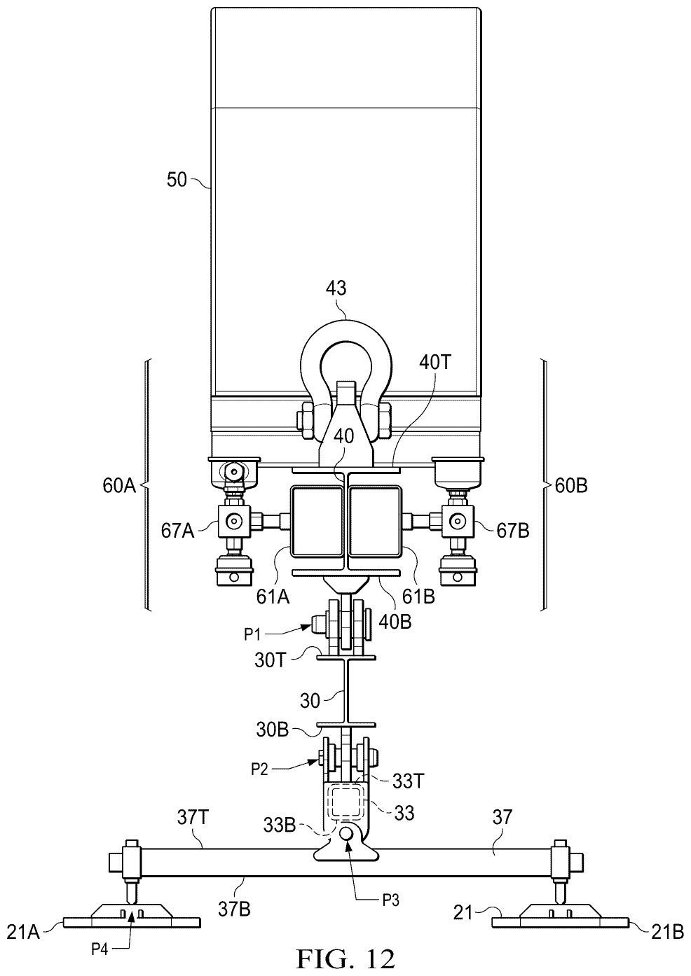

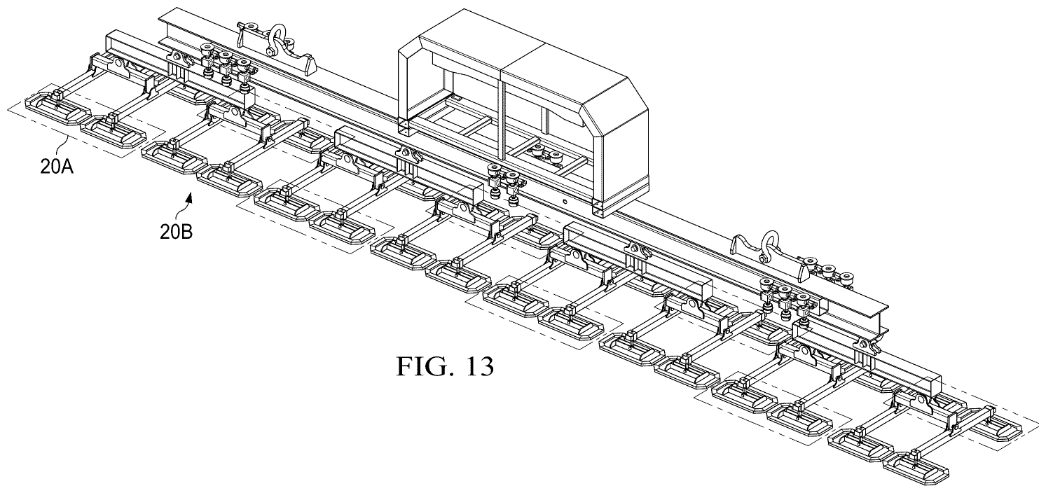

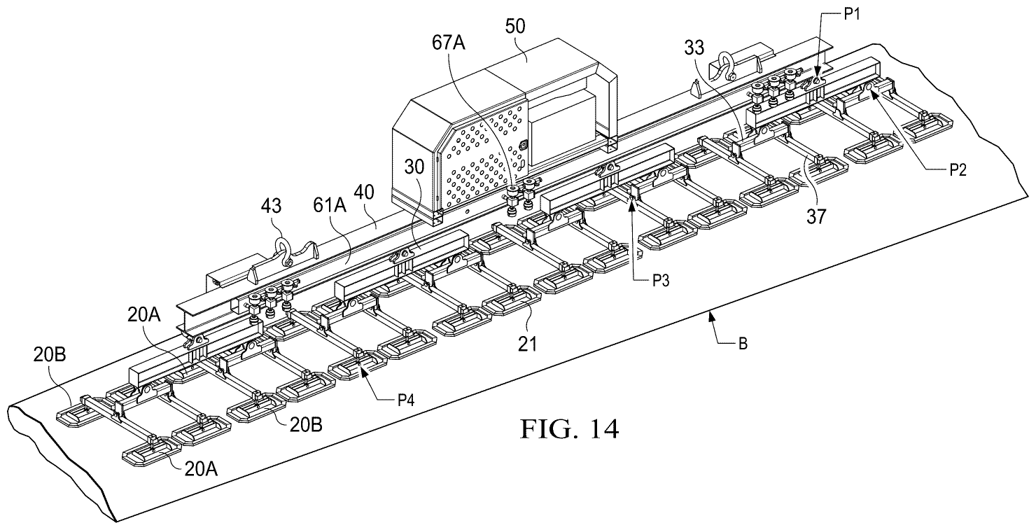

### ELEMENTS AND NUMBERING USED IN THE DRAWINGS AND DESCRIPTION

10 Vacuum material handler
20 Vacuum pad section or vacuum pad lifter section
20A Portion of vacuum pad section connected to first vacuum system
20B Portion of vacuum pad section connected to second vacuum system
21 Vacuum pad or vacuum lifting pad
21A Vacuum pad connected to first vacuum system
21B Vacuum pad connected to second vacuum system
30 Beam or spreader beam
30B Bottom side of beam 30
30T Top side of beam 30
31 End of beam 30
33 Another longitudinally extending beam
33B Bottom side of beam 33
33T Top side of beam 33
35 End of beam 33
37 Other (laterally extending) beam
37B Bottom side of beam 37
37T Top side of beam 37
39 End of beam 37
40 Main (longitudinally extending) beam
40B Bottom side of beam 40
40T Top side of beam 40
41 End of beam 40
43 Lifting point or lifting eye
45 Top side of beam 40
47 Bottom side of beam 40
50 Frame housing first and second engines and first and second vacuum pumps
50A Portion of frame containing first engine and vacuum pump
50B Portion of frame containing second engine and vacuum pump
60 Vacuum system
60A First vacuum system
60B Second vacuum system
61 Vacuum tank
61A First vacuum tank
61B Second vacuum tank
67 Valve
67A First valve
67B Second valve
B Wind turbine rotor blade
P1 First pivot point or pinned connection
P2 Second pivot point or pinned connection
P3 Third pivot point or pinned connection
P4 Fourth pivot point or pinned connection

### DETAILED DESCRIPTION

In embodiments of this disclosure, a vacuum material handler 10 includes a plurality of vacuum pad lifter sections 20 connected to a main beam 40 and in fluid communication with a corresponding vacuum source or system 60. Each section 20 includes pairs of vacuum lifting pads 21. The vacuum system 60 includes an engine and a vacuum pump (not shown) housed by a frame 50 that is connected to the beam 40, a vacuum tank 61 running along the beam 40, and valves 67 which, in turn, connect to the vacuum lifter sections 20 or pads 20.

The engine, vacuum pump, the hoses which connect the pump to the tank 61, and the seals used for the lifting pads 21 are of a kind known in the art of vacuum material handlers. One engine and pump may be housed in a first portion 50A of the frame 50 and the other engine and pump housed in a second portion 51.

In some embodiments, the vacuum pad lifter sections 20 are connected to a smaller longitudinally extending beam 30 connected to the main beam 40. The beam 30 may be a spreader beam having a first length and a second length greater than that of the first length. The end 31 of the beam 30 may extend past the end 41 of the main beam 40. Two or more beams 30 may be used, and the beams 30 may have a same or different length than one another. For example, there may be two end beams 30 having a same length and a middle beam 30 having a different length. The beam or beams 30 may be pivotally connected at P1 to the main beam 40. Each beam 30 is connected to pairs of lifting pads 21.

The pairs of vacuum pads 21 or each vacuum pad lifting section 20 may be connected to a longitudinally extending arm 33 running parallel to the beam 30 and pivotally connected at P2 to the beam 30. At each end 35 of the longitudinally extending arm 33 is a laterally extending arm 37 pivotally connected at P3 to the arm 33. At each end 39 of the laterally extending arm 37 is a vacuum pad 21 pivotally connected at P4 to the arm 37. This pivoting arrangement allows the pad sections 20 to adapt to, and accommodate, the contours of a wind turbine rotor blade. Hangars of a kind known in the art may be used to connect the beam 30 to beam 40 as well as connect the arms 35, 37. The pivot connections P1, P2, P3, and P4 may be pinned connections.

No precise positioning of the blade relative to the vacuum pad sections 20 or pads 21 is required as the pad sections 20 conform to whatever contour of the blade it faces. Nor is a lifting cradle, clamp, or gripper required to support the blade during lifting.

Each vacuum lifting pad sections 20 may comprise an even number of vacuum lifting pads 21 spaced apart to ensure an even load. By way of a non-limiting example, a section 20 may include four or six or eight vacuum lifting pads 21, with half of the pads 21 connected to a first vacuum tank 61A and another half of the pads 21 connected to a second vacuum tank 61B, tanks 61A, 61B being a part of a first and second vacuum system 60A, 60B respectively. Using four pads as an example, two of the four pads 21 of the section 20 are in fluid communication with the first vacuum tank 61A connected to a first engine and vacuum pump (not shown) and another two of the four pads 21 are in fluid communication with the second vacuum tank 61B connected to a second engine and vacuum pump (not shown).

In embodiments, the pair of pads 21 are adjacent one another on a same side of the beam 30 and connected to the same vacuum tank (61A or 61B) but a different lateral beam 37. The pair of pads 21 directly opposite these are arranged similarly but are in communication with a the other tanks (61B or 61A). For example, a first pair of pads 21 on a same side of the beam 30 is in fluid communication with the first vacuum tank 61A and a second pair of pads 21 directly opposite the first pair is in communication with the second vacuum tank 61B. However, the adjacent pair of pads 21 on the same side of the beam 30, and next to the first pair, is connected to the second vacuum tank 61B and the adjacent pair of pads 21 on the same side of the beam 30 and next to the second pair is connected to the first vacuum tank 61, thereby creating a zig pattern within and among the plurality of vacuum pad lifter sections 20 located along the beam 30. A similar zig-zag pattern can be achieved using a one-to-one valve to pad arrangement.

The shape of the lifting pads 21 is a shape effective for use with a wind turbine rotor blade. In some embodiments, the pads 21 are hexagonal shaped. In other embodiments, the pads 21 are square- or rectangular shaped.

A valve 67A, 67B is in communication with each pad or pair of pads 21A, 21B and a corresponding one of the vacuum tanks 61A, 61B of vacuum systems 60A, 60B. As previously described, in embodiments one pad 21 of the pair is on the same side of the beam 30 as the adjacent pad 21 of the pair. The pair of pads 21 directly opposite these are connected to the other vacuum system 60. Should one pad 21 not seal, or the vacuum line becomes damaged, a valve 67 of the first or second vacuum systems 60 will see a pressure higher than that in the vacuum tank 61 and automatically shut off flow to the pad 21 and save the system from leaks. In the event that one of the vacuum tanks 61 ruptures or a valve 67 is knocked loose, the vacuum pump corresponding to that tank 61 or valve 67 will see that the leak is over a predetermined tolerance and shut off. At this point one of the two vacuum systems 60 is lost but the 2:1 vacuum lifting standard for vertical lift is still satisfied (see ASTM BTH-1). The same result applies should an engine or vacuum pump fail.

In embodiments, the lifter 10 can be controlled by a rigger using a hand held PLC (not shown). One or more camera (not shown) can be positioned along the beam, at either end of the beam, in the middle of the beam, or some combination thereof to permit a rigger to observe lifter operations during a lift. A proximity switch or timer (not shown) or some combination of the two may be included and arranged so there is no accidental vacuum release by a rigger during lifting.

A vacuum material handler 10 of this disclosure can lift wind turbine blades weighing up to 30,000 lbs (˜13.5 metric tons). Blades weighing more than this may be lifted by, for example, modifying design variables such as, but not limited to, the handler's dimensions, the size of the beams, the shape or number of lifting pads, and the size of the vacuum source.

In some embodiments, the maximum height of the lifter is less than 10′ (˜0.9 m), maximum width is less than 102″ (˜260 cm), maximum length is less than 40′ (˜12 m), and maximum weight is no more than 15,000 lbs (˜6.8 metric tons). In other embodiments, maximum beam 40 length is 30′ (˜9 m) to help reduce overall weight.

Tag line tubes or spreader bars 30 may be included that can extend roughly 8′ (˜2.5 m) on either side by removing a set of pins and then reinserting the pins to retain the tubes in place. An overall length of 46′ (˜117 cm) can be achieved. In some embodiments, three vacuum lifting pad sections 20 are connected to the end spreader bars 30 with pad sections 20 connected to one or more middle bars 30.

A method of this disclosure for handling a wind turbine rotor blade for connection to a hub connected to a nacelle of a wind turbine tower, includes positioning the vacuum material handler 10 directly above the wind turbine rotor blade; lowering the vacuum material handler 10 to place the lifting pads 21 in contact with portions of the wind turbine rotor blade; applying a vacuum to the lifting pads 21; and after the applying, lifting the wind turbine rotor blade for connection to the hub of the wind turbine tower. Vacuum can continued to be applied to the lifting pads 21 during the connection. No cradle or other supporting structure is required during the lifting and connecting to support a weight of the blade After the connection, the vacuum is released and the vacuum material handler 10 is lowered to ground level for further use or for transport.

While embodiments of a vacuum material handler of this disclosure, and method of its use, have been described, persons of skill in the art may make modifications without departing from the scope of the following claims, the elements and limitations of which are entitled to their full range of equivalents.

What is claimed:

1. A vacuum material handler (10) adapted to lift a wind turbine rotor blade, the vacuum material handing including:
a longitudinally extending main beam (40);
a first vacuum system (60A) and a second vacuum system (60B) connected to the longitudinally extending main beam, each first and second vacuum system including a vacuum tank (61A, 61B), a plurality of valves (67A, 67B) in fluid communication with the vacuum tank, and a plurality of vacuum lifting pads (21A, 21B);
each vacuum lifting pad being in fluid communication with a corresponding one of the valves and arranged to pivot in a upward and a downward direction fore and aft and side to side; and
adjacent vacuum lifting pads of the plurality of vacuum lifting pads being in fluid communication with a different vacuum system than one another.

2. The vacuum material handler of claim 1, wherein the adjacent vacuum lifting pads each comprise a pair of lifting pads.

3. The vacuum material handler of claim 1, wherein the adjacent lifting pads are located on opposite sides of the longitudinally extending main beam from one another.

4. The vacuum material handler of claim 1, wherein the adjacent lifting pads are located on a same side of the longitudinally extending main beam as one another.

5. The vacuum material handler of claim 1, wherein the vacuum tank is at least partially housed by the longitudinally extending main beam.

6. The vacuum material handler of claim 1 further comprising at least one smaller longitudinally extending beam (30) connected to a bottom side (40B) of, and running in a same direction as, the longitudinally extending main beam.

7. The vacuum material handler of claim 6, wherein the at least one smaller longitudinally extending beam is pivotally connected (P1) to the longitudinally extending main beam.

8. The vacuum material handler of claim 6, wherein the at least one smaller longitudinally extending beam is a spreader beam extendible between a first and second length.

9. The vacuum material handler of claim 8, wherein lifting pads of the plurality of lifting pads are connected to a bottom side (30B) of the smaller longitudinally extending beam.

10. The vacuum material handler of claim 6, further comprising another beam (33) pivotally connected (P2) to a bottom side (30B) of the smaller longitudinally extending beam and running in the same direction.

11. The vacuum material handler of claim 10, wherein lifting pads of the plurality of lifting pads are connected to the another beam.

12. The vacuum material handler of claim 10, further comprising two other beams (37) each pivotally connected (P3) to a corresponding end (35) of the another beam and running in a lateral direction.

13. The vacuum material handler of claim 12, wherein lifting pads of the plurality of lifting pads are connected to the two other beams.

14. The vacuum material handler of claim 1, wherein the first and second vacuum systems each meet at least a 2:1 vacuum lifting standard.

15. A method for handling a wind turbine rotor blade for connection to a hub of a wind turbine, the hub being connected to a nacelle of a wind turbine tower, the method comprising:
positioning the vacuum material handler of claim 1 directly above the wind turbine rotor blade;
lowering the vacuum material handler to place the lifting pads in contact with portions of the wind turbine rotor blade;
applying a vacuum to the lifting pads;
after the applying, lifting the wind turbine rotor blade for connection to the hub of the wind turbine;
during the connection, continuing the applying;
and, after the connection, releasing the vacuum.
